(19) United States
(12) Patent Application Publication
(10) Pub. No.: US 2020/0218572 A1
(43) Pub. Date: Jul. 9, 2020

(54) SYSTEM FOR TRANSFORMATION OF RESOURCE ALLOCATIONS OF PREDETERMINED INTERVALS BASED ON DYNAMIC INDICES

(71) Applicant: Brighthouse Services, LLC, Charlotte, NC (US)

(72) Inventors: Michael Anthony Villella, Charlotte, NC (US); Melissa Sue Cox, Arlington, TX (US); Jensen Palencia, Charlotte, NC (US); Alan Scott Assner, Charlotte, NC (US); Tara Jean Figard, Denver, NC (US)

(73) Assignee: Brighthouse Services, LLC, Charlotte, NC (US)

(21) Appl. No.: 16/243,899

(22) Filed: Jan. 9, 2019

(51) Int. Cl. G06F 9/50; G06Q 40/08

(52) U.S. Cl. CPC G06F 9/5011; G06Q 40/08

(57) ABSTRACT

Embodiments of the invention are directed to systems, methods, and computer program products for implementing dynamic resource allocation. The system is configured for transformation of resource allocations of predetermined intervals based on dynamic indices. In some embodiments, the system is configured to determine an adapted resource component for a predetermined time interval of a plurality of time intervals associated with the dynamic resource allocation. Moreover, the system may then identify a cumulative growth rate associated with the adapted resource component. Subsequently, the system may construct a total resource availability for the predetermined time interval based on escalating or modifying a prior total resource availability in direct proportion with the cumulative growth rate.

### BACKGROUND

Existing systems are typically associated with static resource allocations whose progression is typically substantially steady over a time interval. However, such static resource allocations are not flexible and are not configured for adapting to real-time events associated with a user. Moreover, static life insurance allocations typically comprise a fixed progression. Accordingly, there is a need for a resource allocation and dynamic transformation platform that is configured for dynamic progression and is adaptable to real-time events associated with the user.

The novel resource allocation and dynamic transformation platform of the present invention described herein provides a solution to the above technical problem, alleviates the foregoing deficiencies and also provides additional improvements. In some embodiments, novel the resource allocation and dynamic transformation platform of the present invention described herein is configured for operatively combining resource allocations with dynamic indices to provide unique dynamic flexible resource allocations, which also comprises additional benefits, as described in detail herein.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention comprise systems, methods, and computer program products that address these and/or the foregoing deficiencies of conventional systems, addresses the foregoing identified needs and provides improvements to existing technology by providing an innovative system, method and computer program product for implementing dynamic resource allocation. Here, the invention is configured for transformation of resource allocations of predetermined intervals based on dynamic indices. Typically the system comprises: at least one memory device with computer-readable program code stored thereon; at least one communication device; at least one processing device operatively coupled to the first proctor module application and the second proctor module application, the at least one memory device and the at least one communication device. Executing the computer-readable code is configured to cause the at least one processing device to: receive, via an operative communication channel, a request from a user to implement a dynamic resource allocation associated with a predetermined user resource, from a user device. In response, the system may configure the dynamic resource allocation based on at least analyzing the user request, wherein configuring the dynamic resource allocation comprises determining a plurality of time intervals associated with the dynamic resource allocation; and initiate, via the operative communication channel, a first resource transfer from a user resource for a first time interval of the plurality of time intervals, wherein the first resource transfer comprises a first resource transfer value. Next, the system may implement the dynamic resource allocation for the plurality of time intervals. Here, implementing the dynamic resource allocation comprises, for a predetermined time interval of the plurality of time intervals: (i) determining an adapted resource component associated with the predetermined time interval; (ii) determining a cumulative growth rate associated with the adapted resource component, wherein the cumulative growth rate comprises a rate of change of the adapted resource component from a preceding first dynamic index implementation of the adapted resource component at a time interval directly preceding the predetermined time interval; (iii) constructing a total long term resource availability component for the predetermined time interval based on varying a prior total long term resource availability in direct proportion with the cumulative growth rate, wherein the prior long term resource availability is associated with the time interval directly preceding the predetermined time interval; and/or (iv) transforming the adapted resource component by implementing the adapted resource component in a second dynamic index for the predetermined time interval. The system may then transmit a notification to the user device indicating the completion of the dynamic resource allocation.

In some embodiments, or in combination with any of the previous embodiments, the system is further configured to: determine a long term acceleration resource value for the predetermined time interval; and based on at least (i) the determined total long term resource availability and (ii) the determined long term acceleration resource value, determine an associated extended resource value for the predetermined time interval.

In some embodiments, or in combination with any of the previous embodiments, the predetermined time interval of the plurality of time intervals comprises a second time interval of the plurality of time intervals succeeding the first time interval. Here, the system is further configured to initiate, via the operative communication channel, a second resource transfer from the user resource for the second time interval of the plurality of time intervals, wherein the second resource transfer comprises a second resource transfer value. In this regard, the adapted resource component associated with the predetermined time interval is determined based on a combination of the first resource transfer value and the second resource transfer value.

In some embodiments, or in combination with any of the previous embodiments, the system is further configured to: determine that the cumulative growth rate associated with the adapted resource component comprises a negative value; and in response to determining that the constructed total long term resource availability component for the predetermined time interval is below a predetermined threshold floor value, automatically and in real-time, construct the total long term resource availability component such that the total long term resource availability component comprises the predetermined threshold floor value.

In some embodiments, or in combination with any of the previous embodiments, the system is further configured to: determine a life event allocation resource component for the predetermined time interval.

In some embodiments, or in combination with any of the previous embodiments, configuring the dynamic resource allocation further comprises receiving a user input comprising the resource transfer value, the dynamic index, and/or at least one life event allocation resource component associated with the dynamic resource allocation.

In some embodiments, or in combination with any of the previous embodiments, the dynamic resource allocation is associated with a long term care (LTC) type.

In some embodiments, or in combination with any of the previous embodiments, the system is further configured to: identify a life event modification trigger associated with the predetermined time interval; and in response to identifying the life event modification trigger, automatically and in real-time, modify the dynamic resource allocation for a second time interval of the plurality of time intervals succeeding the predetermined time interval.

In some embodiments, or in combination with any of the previous embodiments, the predetermined time interval is the first time interval of the plurality of time intervals.

In some embodiments, or in combination with any of the previous embodiments, the predetermined time interval is a second time interval of the plurality of time intervals.

In some embodiments, or in combination with any of the previous embodiments, the predetermined time interval is a third time interval of the plurality of time intervals.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 depicts resource allocation and dynamic transformation platform environment 100, in accordance with some embodiments of the present invention;

FIG. 2 depicts a high level process flow 200 associated with resource allocation and dynamic transformation, in accordance with some embodiments of the invention;

FIG. 3 depicts a schematic representation 300 of a resource allocation implementation, in accordance with some embodiments of the invention;

FIG. 4A depicts a high level process flow 400A associated with resource allocation and dynamic transformation for a first time period, in accordance with some embodiments of the invention;

FIG. 4B depicts a high level process flow 400B associated with resource allocation and dynamic transformation for subsequent time period after that of the process flow 400A, in accordance with some embodiments of the invention;

FIGS. 5A and 5B depict a single-pay market growth type dynamic resource allocation implementation 500A-500B, in accordance with some embodiments of the invention; and

FIGS. 6A and 6B depict a multi-pay market growth type dynamic resource allocation implementation 600A-600B, in accordance with some embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In some embodiments, the terms “resource transfer value” or “premium” as used herein may refer to the amount of money a resource allocation provider (e.g., an entity or insurer) requires to provide a coverage associated with a resource allocation (e.g., insurance policy). Typically, in some embodiments, a policy owner (e.g., the user or customer) periodically transmits the “resource transfer value” or “premium” to the resource allocation provider (e.g., an entity or insurer). In some embodiments, the term “resource transfer value” as used herein may refer to a net premium, i.e., the expected present value of a resource allocation's (e.g., insurance policy) benefits less the expected present value of future premiums. Here, net premium is typically determined based on subtracting a premium load from a gross premium. In some embodiments, the term “resource transfer value” may refer to a gross premium.

In some embodiments, the term “cumulative resource transfer value (e.g., cumulative net premium),” as used herein may refer to the sum of resource transfer values (e.g., consecutive premiums) over the course of a period of time.

In some embodiments, the terms “adapted resource component” or “cash value,” as used herein may refer to the resource value (i.e., cash amount) available to the named policy owner (e.g., the user or customer), provided by the resource allocation provider (e.g., an entity or insurer) carrier upon cancellation of the resource allocation (e.g., insurance contract). In accordance with the embodiments of the invention, the adapted resource component is implemented in accordance with dynamic resource allocation of the present invention. Moreover, dynamic growth of the adapted resource component drives total LTC resource availability.

In some embodiments, the terms “life event allocation resource component” or “death benefit” as used herein may refer to the amount payable by a resource allocation (e.g., a life insurance policy) in the event of the death of the named insured (e.g., the user or customer).

In some embodiments, “long term care (LTC)” may refer to care and service required by a user or an individual on a continuing basis who can no longer perform some or all of the activities of daily living (ADLs). Long-term care (LTC) coverage may provide funds for nursing-home care, home-health care, personal, or adult day care, or LCT coverage may be provided based on an indemnity basis. In some embodiments, life insurance or deferred annuity policies have a built-in benefit to pay for long-term care expenses such as home health care, assisted living, or nursing home care.

In some embodiments, the terms “total LTC resource availability” or “total LTC benefit” as used herein may refer to the total resource available towards LTC for a particular resource allocation of a user.

In some embodiments, the terms “long term care (LTC) acceleration resource value” or “ LTC acceleration of death benefit rider,” as used herein may refer to resource availability (benefit) typically attached to a resource allocation (e.g., life insurance policy) that is configured to enable the policyholder (e.g., the user or customer) to receive resources (e.g., payments/advances) against a death benefit component of the resource allocation (e.g., life insurance policy). In some embodiments, a “rider” is a separate benefit that's attached to the basic policy.

In some embodiments, the terms “extended resource value” or “extension of benefits rider” as used herein may refer to resource availability (benefit) after exhaustion of long term care (LTC) acceleration resource value.

In some embodiments, the terms “predetermined time interval” or “predetermined cycle,” as used herein may refer to a one or more time intervals associated with the resource allocation (e.g., a year). “Time interval” in some instances may refer to “Beginning of Year (BOY)”.

In some embodiments, the term “resource ceiling value,” as used herein may refer to a face value of the resource allocation. For instance, the face value may refer to the amount of insurance provided.

In some embodiments, the term “cumulative growth rate” or “dynamic indexed growth rate,” as used herein may refer to the change in corresponding to an associated dynamic index (e.g., stock index) based on performance of the index. In the unique implementation of the present system the “cumulative growth rate” or “dynamic indexed growth rate” drives a corresponding growth rate in the “adapted resource component (cash value)” and/or “total LTC resource availability/total LTC benefits.”

In some embodiments, “long term” as used herein may refer to a time span associated with a plurality of time intervals.

In some embodiments, an “entity” or “enterprise” as used herein may be any institution or establishment, associated with a network connected resource transfer platform, and particularly resource allocation and processing (e.g., insurance type resource allocations). As such, the entity may be any institution, financial institution, group, company, organization, association, merchant, establishment, union, authority and/or the like.

As described herein, a “user” is an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

In the instances where the entity is a resource entity (e.g., a financial institution, or company providing insurance type resource allocations), a user may be an individual or entity with one or more relationships, affiliations or accounts with the entity (for example, the merchant, the financial institution). In some embodiments, the user may be an entity or financial institution employee (e.g., an underwriter, a project manager, an IT specialist, a manager, an administrator, an internal operations analyst, bank teller or the like) capable of operating the system described herein. In some embodiments, a user may be any individual or entity who has a relationship with a customer of the entity or financial institution. For purposes of this invention, the term “user” and “customer” may be used interchangeably. A “technology resource” or “account” may be the relationship that the user has with the entity. Examples of technology resources include a deposit account, such as a transactional account (e.g. a banking account), a savings account, an investment account, a money market account, a time deposit, a demand deposit, a pre-paid account, a credit account, a non-monetary user profile that includes only personal information associated with the user, or the like. The technology resource or account is typically associated with and/or maintained by an entity, and is typically associated with a resource account value (e.g., quantity of resources in the account) technology infrastructure such that the resource or account may be accessed, modified or acted upon by the user electronically, for example using or transaction terminals, user devices, merchant systems, and the like. In some embodiments, the entity may provide one or more technology instruments or financial instruments to the user for executing resource transfer activities or financial transactions. In some embodiments, the technology instruments/financial instruments like online interfaces or mobile interfaces and applications are associated with one or more resources or accounts of the user, that allow the user to monitor, modify and/or provide input resource/account. In some embodiments, the technology instruments/financial instruments like electronic tokens, credit cards, debit cards, checks, loyalty cards, entity user device applications, account identifiers, routing numbers, passcodes and the like are associated with one or more resources or accounts of the user. As discussed, in some embodiments, the entity represents a vendor or a merchant with whom the user engages in financial (for example, resource transfers like purchases, payments, returns, enrolling in merchant accounts and the like) or non-financial transactions (for resource transfers associated with loyalty programs and the like), either online or in physical stores.

As used herein, a “user interface” may be a graphical user interface. Typically, a graphical user interface (GUI) is a type of interface that allows users to interact with electronic devices such as graphical icons and visual indicators such as secondary notation, as opposed to using only text via the command line. That said, the graphical user interfaces are typically configured for audio, visual and/or textual communication. In some embodiments, the graphical user interface may include both graphical elements and text elements. The graphical user interface is configured to be presented on one or more display devices associated with user devices, entity systems, auxiliary user devices, processing systems and the like.

An electronic activity, also referred to as a technology activity, such as a “resource transfer” or “transaction”, may refer to any activities or communication between a user or entity and the financial institution, between the user and the entity, resource transformations performed by the entity itself, activities or communication between multiple entities, communication between technology applications and the like. A resource transfer may refer to a payment, processing of funds, purchase of goods or services, a return of goods or services, a payment transaction, a credit transaction, or other interactions involving a user's resource or account. In the context of a financial institution or a resource entity such as a merchant, a resource transfer may refer to one or more of: a sale of goods and/or services, initiating an automated teller machine (ATM) or online banking session, an account balance inquiry, a rewards transfer, an account money transfer or withdrawal, opening a bank application on a user's computer or mobile device, a user accessing their e-wallet, or any other interaction involving the user and/or the user's device that invokes or is detectable by the financial institution. Unless specifically limited by the context, a “resource transfer” a “transaction”, “transaction event” or “point of transaction event” refers to any activity initiated between a user and a resource entity such as a merchant, between the user and the financial instruction, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include electronic funds transfers between accounts, etc. When discussing that resource transfers or transactions are evaluated it could mean that the transaction has already occurred, is in the process of occurring or being processed, or it has yet to be processed/posted by one or more financial institutions. In some embodiments, a resource transfer or transaction may refer to non-financial activities of the user. In this regard, the transaction may be a customer account event, such as but not limited to the user renewing benefits/riders associated with the user' resource allocations, modifying/obtaining benefits/riders associated with the user' resource allocations, modifying premium resource values for an upcoming time interval and/or the like.

In accordance with embodiments of the invention, the term “user” may refer to a customer or the like, who utilizes an external apparatus such as a user device, for executing resource transfers or transactions. The external apparatus may be a user device (computing devices, mobile devices, wearable devices, and the like), a payment instrument (credit cards, debit cards, checks, digital wallets, currency, loyalty points), and/or payment credentials (account numbers, payment instrument identifiers). In accordance with embodiments of the invention, the term “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

As discussed, existing systems are typically associated with static resource allocations whose progression/growth is typically substantially steady over a time interval. Examples of such static resource allocations include life insurance allocations for users. However, such static life insurance allocations are not flexible and are not configured for adapting to life events associated with the user. Moreover, static life insurance allocations typically comprise a fixed progression/growth. Accordingly, there is a need for a resource allocation and dynamic transformation platform that is configured for dynamic progression/growth and is adaptable to life events associated with the user. In this regard, in some embodiments, the resource allocation and dynamic transformation platform of the present invention described herein, is configured for operatively combining resource allocations with dynamic indices to provide unique dynamic flexible resource allocations that address the foregoing deficiencies. In some embodiments, the resource allocation and dynamic transformation platform of the present invention provides a Long-Term Care (LTC) insurance type dynamic resource allocation for resources associated with the user, which also comprises additional benefits and riders as described in detail herein.

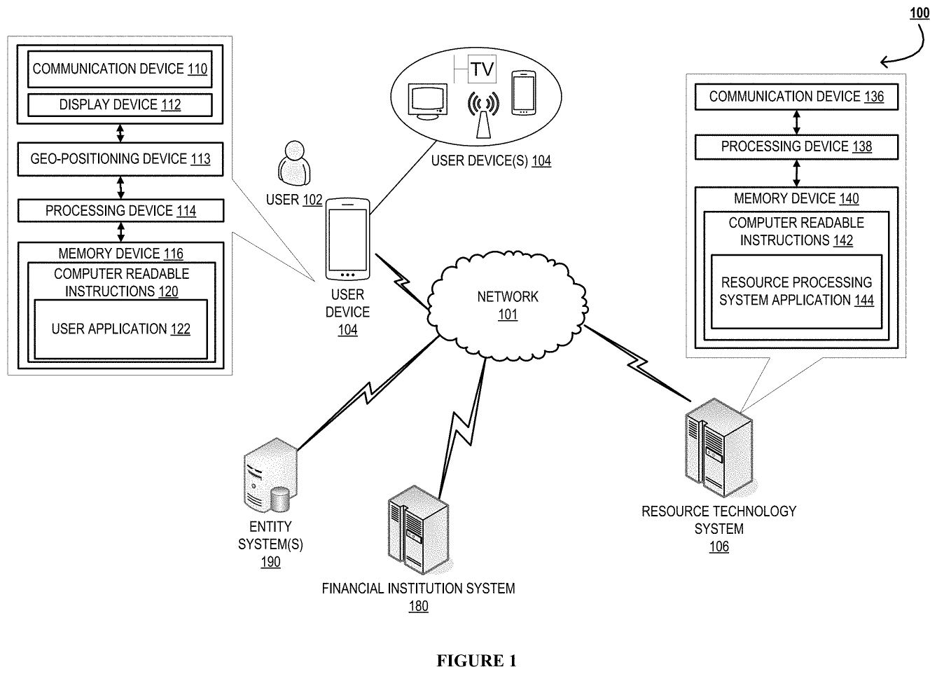

FIG. 1 illustrates resource allocation and dynamic transformation platform environment 100, in accordance with one embodiment of the present invention. As illustrated in FIG. 1, a resource technology system 106, configured for providing transformation of resource allocations of predetermined intervals based on dynamic indices. The resource technology system is operatively coupled, via a network 101 to one or more user devices 104, to financial institution systems 180, one or more entity systems 190, and other external systems/third-party servers not illustrated herein. In this way, the resource technology system 106 can send information to and receive information from multiple user devices 104 to provide resource allocation and dynamic transformation capabilities to resource allocations associated with a user 102. In some embodiments, at least a portion of the resource allocation and dynamic transformation platform is typically configured to reside on the system 106 (for example, at the resource processing system application 144), and/or on other devices that facilitates transformation of resource allocations of predetermined intervals based on dynamic indices in an integrated manner. In some embodiments, at least a portion of the resource allocation and dynamic transformation platform is configured to reside on the user device 104 (for example, at the user application 122), and/or on other devices of the environment 100. Furthermore, the resource allocation and dynamic transformation platform is capable of seamlessly adapting to dynamic index triggers retrieved from the one or more entity systems 190.

The network 101 may be a global area network (GAN), such as the Internet, a wide area network (WAN), a local area network (LAN), or any other type of network or combination of networks. The network 101 may provide for wireline, wireless, or a combination wireline and wireless communication between devices on the network 101. The network 101 is configured to establish an operative connection between systems/devices, for example establishing a communication channel, automatically and in real time, between the resource technology system 106 and the one or more entity systems 190, between the resource technology system 106 and the financial institution system 180, and/or between the resource technology system 106 and the one or more user devices 104. In some embodiments, the network 101 may take the form of contactless interfaces, short range wireless transmission technology, such near-field communication (NFC) technology, Bluetooth® low energy (BLE) communication, audio frequency (AF) waves, wireless personal area network, radio-frequency (RF) technology, and/or other suitable communication channels.

In some embodiments, the user 102 is an individual that wishes to conduct one or more activities with resource entities (e.g., resource allocation of a Long-Term Care (LTC) insurance type), for example using the user device 104. In some embodiments, the user 102 may access the resource technology system 106, and/or the financial institution system 180 through a user interface comprising a webpage or a user application. Hereinafter, “user application” is used to refer to an application on the user device 104 of the user 102, a widget, a webpage accessed through a browser, and the like. In some embodiments the user application is a user application 122, referred to as a user application 122 herein, stored on the user device 104. In some embodiments the user application 122 may refer to a third party application or a user application stored on a cloud used to access the resource technology system 106 through the network 101. In some embodiments, the user application is stored on the memory device 140 of the resource technology system 106, and the user interface is presented on a display device of the user device 104, while in other embodiments, the user application is stored on the user device 104. The user 102 may subsequently navigate through the interface, perform one or more searches or initiate one or more activities or resource transfers, renew/modify benefits/riders associated with the user' resource allocations, modify/authorize premium resource values for an upcoming time interval, etc. using a user interface provided by the user application 122 of the user device 104.

FIG. 1 also illustrates the user device 104. The user device 104, herein referring to one or more user devices, wherein each user device 104 may generally comprise a communication device 110, a display device 112, a geo-positioning device 113, a processing device 114, and/or a memory device 116. The user device 104 is a computing system that allows a user 102 to interact with other systems to initiate or to complete activities, resource transfers, and transactions for products, and the like. The processing device 114 is operatively coupled to the communication device 110 and the memory device 116. The processing device 114 uses the communication device 110 to communicate with the network 101 and other devices on the network 101, such as, but not limited to the resource technology system 106. As such, the communication device 110 generally comprises a modem, server, or other device for communicating with other devices on the network 101. In some embodiments the network 101 comprises a network of distributed servers. In some embodiments, the processing device 114 may be further coupled to a display device 112, a geo-positioning device 113, and/or a transmitter/receiver device, not indicated in FIG. 1. The display device 112 may comprise a screen, a speaker, a vibrating device or other devices configured to provide information to the user. In some embodiments, the display device 112 provides a presentation of the user interface of the user application 122. The geo-positioning device 113 may comprise global positioning system (GPS) devices, triangulation devices, accelerometers, and other devices configured to determine the current geographic location of the user device 104 with respect to satellites, transmitter/beacon devices, telecommunication towers and the like. In some embodiments the user device 104 may include authentication devices like fingerprint scanners, heart-rate monitors, microphones and the like that are configured to receive bio-metric authentication credentials from the user.

The user device 104 comprises computer-readable instructions 120 stored in the memory device 116, which in one embodiment includes the computer-readable instructions 120 of the user application 122. In this way, users 102 may authenticate themselves, initiate activities, and communicate with the resource technology system 106 using the user interface of the user device 104. As discussed previously, the user device 104 may be, for example, a desktop personal computer, a mobile system, such as a cellular phone, smart phone, personal data assistant (PDA), laptop, wearable device, a smart TV, a smart speaker, a home automation hub, augmented/virtual reality devices, or the like. The computer readable instructions 120, when executed by the processing device 114 are configured to cause the user device 104 and/or processing device 114 to perform one or more steps described in this disclosure, or to cause other systems/devices to perform one or more steps described herein.

As further illustrated in FIG. 1, the resource technology system 106 generally comprises a communication device 136, at least one processing device 138, and a memory device 140. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 138 is operatively coupled to the communication device 136 and the memory device 140. The processing device 138 uses the communication device 136 to communicate with the network 101 and other devices on the network 101, such as, but not limited to the user device 104, the one or more entity systems 190, the financial institution system 180 and/or the like. As such, the communication device 136 generally comprises a modem, server, wireless transmitters or other devices for communicating with devices on the network 101.

As further illustrated in FIG. 1, the resource technology system 106 comprises computer-readable instructions 142 stored in the memory device 140, which in one embodiment includes the computer-readable instructions 142 of a resource processing system application 144 (also referred to as a “system application”). The computer readable instructions 142, when executed by the processing device 138 are configured to cause the system 106/processing device 138 to perform one or more steps described in this disclosure to cause out systems/devices to perform one or more steps described herein relating to transformation of resource allocations of predetermined intervals based on dynamic indices. In some embodiments, the memory device 140 includes a data storage for storing data related to user transactions and resource entity information, but not limited to data created and/or used by the resource processing system application 144.

In the embodiment illustrated in FIG. 1, and described throughout much of this specification, a “system” configured for performing one or more steps described herein refers to the resource technology system 106 (via the resource processing system application 144), that may perform one or more user activities either alone or in conjunction with the user device 104, the one or more entity systems 190, the financial institution system 180 and/or the like. The functions, and features of the resource allocation and dynamic transformation platform will now be described in detail.

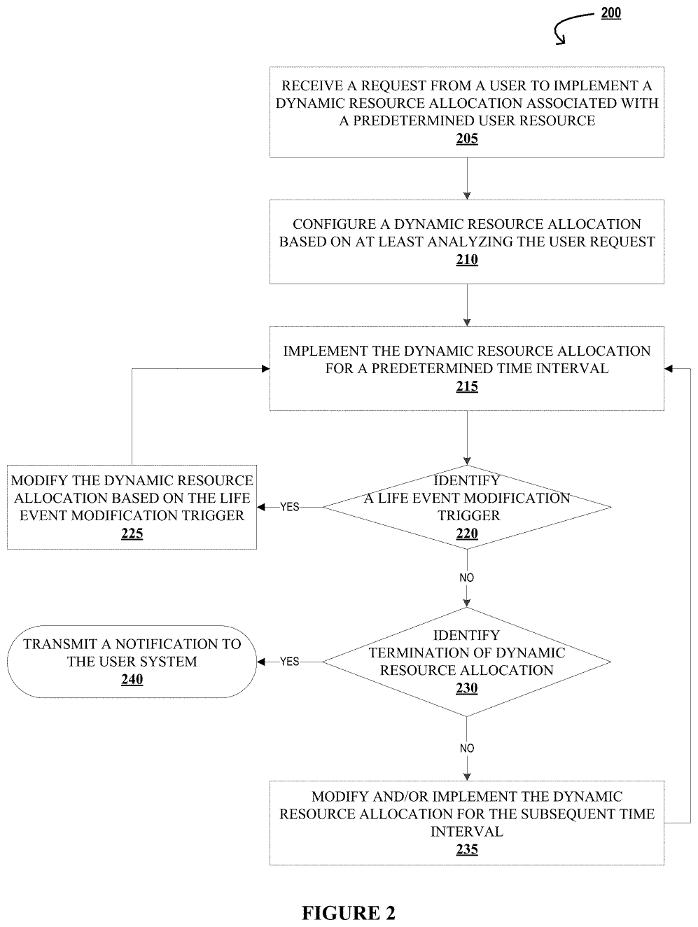

FIG. 2 illustrates a high level process flow 200 associated with resource allocation and dynamic transformation, in accordance with some embodiments of the invention.

At block 205, the system may receive a request from a user to implement a dynamic resource allocation associated with a predetermined user resource. The dynamic resource allocation is typically a long term care (LTC) type insurance. This request may be received in person, over the phone, via the user device 104, via an email or an online form transmitted over a network, or any other suitable manner.

After receiving such a request to implement a dynamic resource allocation, at block 210, the system may then configure and customize a dynamic resource allocation based on at least analyzing the user request. Here, the user may choose one or more available configurations of dynamic resource allocations (e.g., choose one or more indexes, choose one or more parameters associated with benefits), specify resource transfer (premium) values, etc. The system may then configure the dynamic resource allocation accordingly.

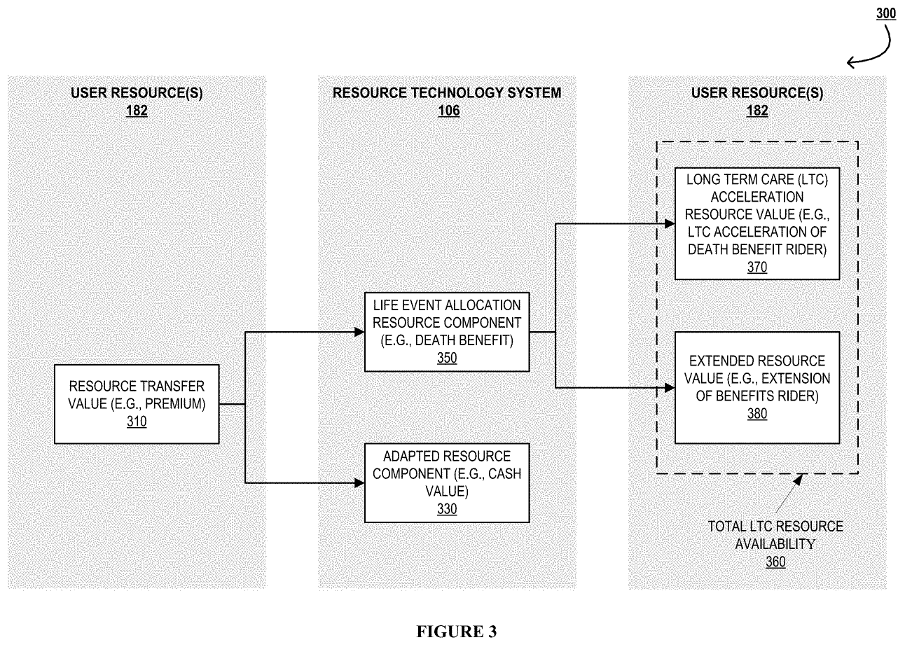

Next, the system may implement the dynamic resource allocation for a predetermined time interval, as depicted by block 215. The implementation of the dynamic resource allocation of the present invention will be described in greater detail, with respect to FIGS. 3 to 6B later on. Typically, the dynamic resource allocation is associated with a predetermined number of time intervals (e.g., 5, 6. 10. 15, 20, etc.) (also referred to as “a plurality of time intervals”), each having a constant or variable time span (e.g., a constant time span of 1 year). In general, during the implementation of the dynamic resource allocation, for each of the predetermine time intervals, the system is configured to, for each time interval of the plurality of time intervals, receive a resource transfer value (e.g., premium), determine a first adapted resource component (e.g., cash value determined based on subtracting an annual deduction from the net premium), transform the adapted resource component by implementing the adapted resource component in a dynamic index (e.g., driving the growth of the cash value based on the corresponding growth of dynamic index), determine a first life event allocation resource component (e.g., death benefit) comprising (i) a long term care (LTC) acceleration resource value (e.g., LTC acceleration of death benefit rider) and (ii) an extended resource value (e.g., extension of benefits rider). The sum of the (i) LTC acceleration resource value (e.g., LTC acceleration of death benefit rider) and (ii) extended resource value (e.g., extension of benefits rider) forms the total LTC resource availability, also referred to as long term resource availability (e.g., total LTC benefit) (illustrated by FIGS. 3-6B).

In some embodiments, the system may identify whether a life event modification trigger is present, as illustrated by block 220. The life event modification trigger may be associated with one or more of triggering of the life event allocation resource component (e.g., death benefit) payment to the user, long term care (LTC) acceleration resource value payment to the user, extended resource value (e.g., extension of benefits rider) payment to the user, modifications to the rider selection/configuration for subsequent time intervals by the user, modifications to the resource transfer value (premium) for subsequent time intervals by the user, and/or the like. In response to the positive trigger identification, the system may modify the dynamic resource allocation in accordance the type of life event triggered, as indicated by block 225. Here, the control may flow back to the implementation of the dynamic resource allocation for the succeeding time interval at block 215.

Alternatively, in response to the lack of life event trigger modification, the system may then identify whether the resource implementation is active or whether there has been termination of dynamic resource allocation at block 230. In response to determining that the policy period or the resource allocation has not been completed (i.e., the current time interval has not exceeded the predetermined number of time intervals or plurality of time intervals associated with the resource implementation), the system may modify and/or implement the dynamic resource allocation for the subsequent time interval, as illustrated by block 235. Here, the control may flow back to the block 215. These steps 215-235 may be performed until the termination of the resource allocation, whence the system may transmit a notification to the user system as indicated by block 240. This notification may be accompanied by one or more benefits or payment or resource transfers to the user that are associated with the implemented dynamic resource allocation.

FIG. 3 illustrates a schematic representation 300 of a resource allocation implementation associated with a long term care (LTC) type insurance, in accordance with some embodiments of the invention. As discussed previously, the long term care (LTC)” may refer to care and service required by a user or an individual on a continuing basis who can no longer perform some or all of the activities of daily living (ADLs). Long-term care (LTC) coverage may provide funds for nursing-home care, home-health care, personal, or adult day care. In some embodiments, life insurance or deferred annuity policies have a built-in benefit to pay for long-term care expenses such as home health care, assisted living, or nursing home care.

To commence the resource allocation implementation associated with a LTC type insurance, typically, a resource transfer value 310 (e.g., a premium) is transmitted to the system from one or more user resources 182 (e.g., an indexed account, an investment account, a transactional account, a savings account, a wire transfer, associated with the user 102). The resource transfer value 310 or premium refers to the amount of resources transferred to the system (e.g., a resource allocation provider, an insurer, etc.) by the user102 for implementing the LTC type insurance. This resource transfer value 310 (e.g., a premium) may be transmitted to the system, periodically, at or before the commencement of an upcoming time interval of a plurality of time intervals associated with the resource allocation. Here, the user may be a policy owner associated with the LTC type insurance.

The resource transfer value 310 (e.g., a premium) produces an adapted resource component 330 or cash value, typically performed by the system. The adapted resource component 330 or cash value typically comprises the resource value (i.e., cash amount) available to the user. In some embodiments, the adapted resource component 330 or cash value is driven by (or directly proportional to) the growth of associated dynamic index cash value implementation of a preceding time interval.

The resource transfer value 310 (e.g., a premium) also produces a life event allocation resource component 350 or death benefit, typically ascertained by the system based on growth of the adapted resource component. The life event allocation resource component 350 or death benefit typically comprises the amount payable by the dynamic resource allocation in the event of the death of the user. In some embodiments, the life event allocation resource component 350 or death benefit is also driven by (or directly proportional to) the growth of associated dynamic index cash value implementation of a preceding time interval.

The life event allocation resource component 350 or death benefit, typically determines (i) a long term care (LTC) acceleration resource value 370 (e.g., LTC acceleration of death benefit rider) and (ii) an extended resource value 380 (e.g., extension of benefits rider).

The sum of the (i) LTC acceleration resource value 370 (e.g., LTC acceleration of death benefit rider) and (ii) extended resource value 380 (e.g., extension of benefits rider) forms the total LTC resource availability 360, also referred to as long term resource availability (e.g., total LTC benefit). The LTC acceleration resource value 370 or LTC acceleration of death benefit rider typically comprises resource availability (benefit) against the death benefit component of the resource allocation. The extended resource value 380 or extension of benefits rider typically comprises resource availability (benefit) after exhaustion of long term care (LTC) acceleration resource value.

In some embodiments, the total LTC resource availability 360 (also referred to as long term resource availability) is directly proportional to the growth of associated dynamic index cash value implementation of a preceding time interval. This dynamic LTC resource availability 360 dictates the available extended resource value 380, for a static LTC acceleration resource value 370, as will be described in detail below.

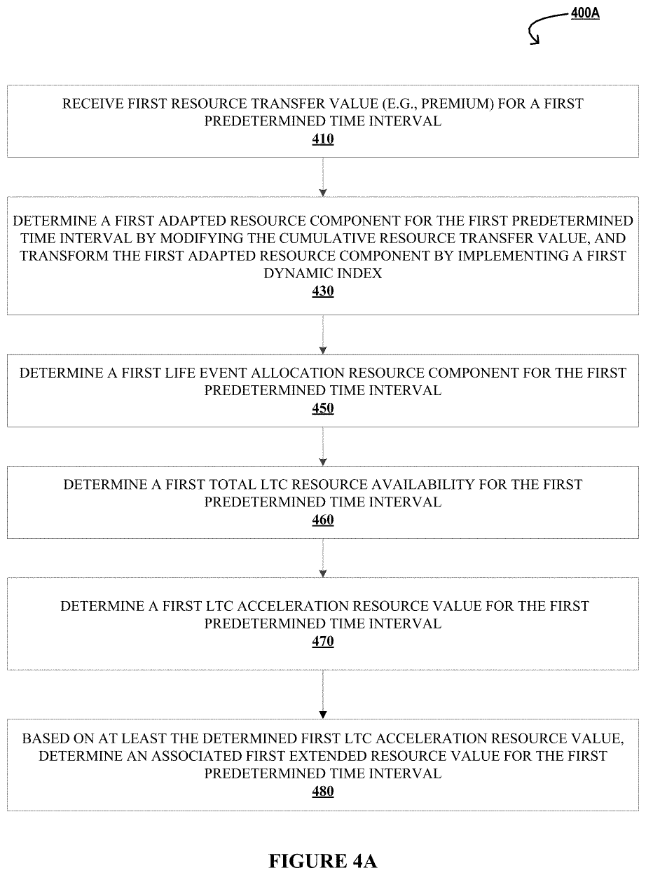

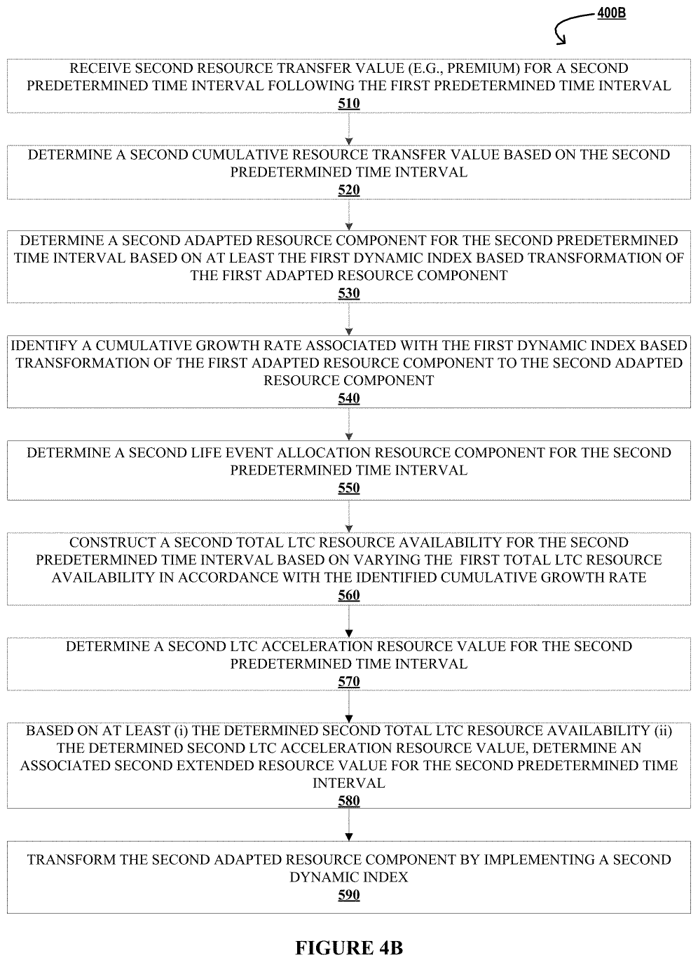

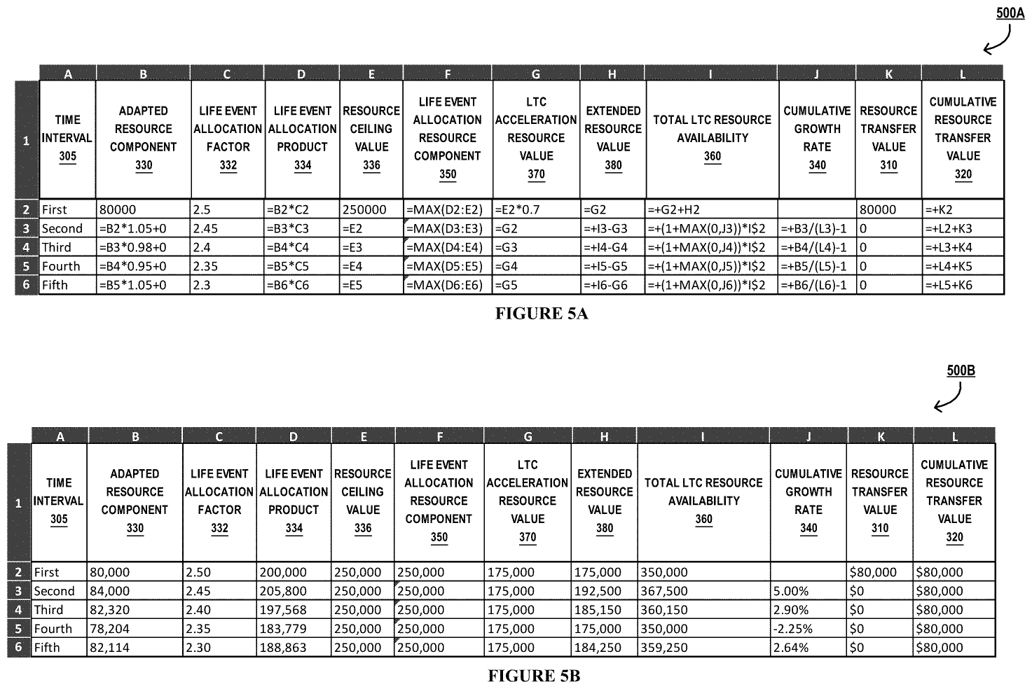

FIG. 4A illustrates a high level process flow 400A associated with resource allocation and dynamic transformation for a first time period, in accordance with some embodiments of the invention. FIGS. 5A and 5B illustrate a single-pay market growth type dynamic resource allocation implementation 500A-500B, in accordance with some embodiments of the invention. The resource allocation and dynamic transformation for a first time period will be described with reference to the non-limiting illustrative example of a single-pay market growth type dynamic resource allocation implementation 500A-500B of FIGS. 5A-5B, where there is only a one-time resource transfer/payment of premium at the outset. Specifically, FIG. 5A illustrates the variables and calculations, while FIG. 5B illustrates the corresponding illustrative numerical result.

In in some embodiments, the system may initiate and/or receive first resource transfer value (e.g., premium) for a first predetermined time interval from a user resource associated with a user, as illustrated by block 410. As indicated by cell K2, at the beginning of the first time interval 305 at cell A2, the system receives a resource transfer value of 80000. The cumulative resource transfer value 320 at block L2 is the same as the premium.

At block 430, in some embodiments, the system may determine a first adapted resource component (cash value). As illustrated in FIGS. 5A-5B, at the beginning of the first time interval 305 at cell A2, the system may determine that the first adapted resource component 330 (cash value) at cell B2 is 80000 (the same as the premium because this is prior to any dynamic index implications). That said, in other embodiments, the system may determine that the first adapted resource component 330 (cash value) at cell B2 is less than the premium (e.g., based on deducting predetermined costs).

Next, at block 450 the system may determine a first life event allocation resource component 350 or death benefit for the first predetermined time interval, in some embodiments. Here, in some embodiments, the system may first identify a predetermined life event allocation factor (e.g., a maximum death benefit (MDBF)) 332 (e.g., having a value of 2.5 at cell C2) and multiply it with the associated first adapted resource component 330 (cash value) at cell B2 to determine a life event allocation product 334 (having a value of 200,000 at cell D2). Next, the system may identify a resource ceiling value 336 or face value of resource allocation, which is typically constant (e.g., 250,000). The resource ceiling value 336 may be the amount of insurance provided, in some embodiments. The system may then determine the first life event allocation resource component 350 or death benefit for the first predetermined time interval to be the greater of the life event allocation product 334 and the resource ceiling value 336/ face value (e.g., 250,000 at cell F2).

Next, the system may determine a first total LTC resource availability 360 (also referred to as a first long term resource availability) for the first predetermined time interval, as depicted by block 460. Here, first, the system may determine a first LTC acceleration resource value 370 or a first long term acceleration resource value 370 (LTC acceleration of death benefit rider of value 175,000 at cell G2) for the first predetermined time interval based on a predetermined factor (e.g., 0.7) of the associated resource ceiling value 336 (e.g., 250,000 at cell F2), as illustrated by block 470. Next, based on at least the determined first LTC acceleration resource value 370 (LTC acceleration of death benefit rider), the system may determine an associated first extended resource value 380 (extension of benefits rider of value 175,000 at cell H2 same as that of the LTC acceleration resource value 370) for the first predetermined time interval, at block 480. Subsequently, the system may combine/add the (i) LTC acceleration resource value 370 (e.g., LTC acceleration of death benefit rider) and (ii) extended resource value 380 (e.g., extension of benefits rider) to determine the total LTC resource availability 360 or total long term resource availability 360 (e.g., total LTC benefit of value 350,000 at cell 12). The control may then flow to block 510 of FIG. 4B for implementation of the second dynamic resource allocation in the second time interval, as described below. Moreover, as indicated by block 430, the system also typically transforms the first adapted resource component 330 (cash value) by implementing a first dynamic index (e.g. stock index) using the resources of the first adapted resource component 330 for the duration of the first time interval, resulting in the next, second time interval.

FIG. 4B illustrates a high level process flow 400B associated with resource allocation and dynamic transformation for subsequent time period after that of the process flow 400A, in accordance with some embodiments of the invention. The resource allocation and dynamic transformation for the subsequent second time period will also be described with reference to the non-limiting illustrative example of a single-pay market growth type dynamic resource allocation implementation 500A-500B of FIGS. 5A-5B. Specifically, FIG. 5A illustrates the variables and calculations, while FIG. 5B illustrates the corresponding illustrative numerical result.

In in some embodiments, the system may receive second resource transfer value (e.g., premium), as illustrated by block 510. However, because the dynamic resource allocation implementation 500A-500B of FIGS. 5A-5B is of a single-pay type, the second resource transfer value at cell K3 is indicated as zero. Next, at block 520 in some embodiments, the system may determine a second cumulative resource transfer value based on the second predetermined time interval. Again, due to the single-pay type implementation in FIGS. 5A-5B, the cumulative resource transfer value 320 at block L3 remains the same.

At block 530, the system may then determine a second adapted resource component for the second predetermined time interval based on at least the first dynamic index based transformation of the first adapted resource component, in some embodiments. As discussed, in the previous iteration at process flow 400A, the system implements the first dynamic index (e.g. stock index) using the resources of the first adapted resource component 330 (cell B2) for the duration of the first time interval. At the end of the first time interval, i.e., at the beginning of the second time interval at cell A3, the adapted resource component 330 at cell B3 may have grown (or reduced) in direct proportionality with the associated first dynamic stock index. As illustrated in FIGS. 5A-5B, at the beginning of the second time interval 305 at cell A3, the system may determine that the second adapted resource component 330 (cash value) at cell B3 has now grown to a value of 84,000 (from the initial value of 80,000). In some embodiments, the value 84,000 also incorporates a deduction for an annual reduction (and/or other deductions).

Next, the system may identify a cumulative growth rate 340 associated with the first dynamic index based transformation of the first adapted resource component to the second adapted resource component, as depicted by block 540. Here, as illustrated by FIGS. 5A-5B, the system may determine a cumulative growth rate 340 of 5% at cell J3, based on determining the rate of change of the current adapted resource component 330 at cell B3 (84,000) from the initial cumulative resource transfer value 320 at block L3.

In in some embodiments, the system may determine a second life event allocation resource component 350 or death benefit for the second predetermined time interval, as illustrated by block 550. Similar to the block 450 previously, here, the system may first identify a predetermined life even allocation factor (MDBF) 332 (e.g., having a value of 2.45 at cell C3) and multiply it with the associated second adapted resource component 330 (cash value) at cell B3 to determine a life event allocation product 334 (having a value of 205,800 at cell D3). Next, the system may identify a resource ceiling value 336 or face value of resource allocation, which is typically constant (e.g., 250,000 at cell E3). The system may then determine the second life event allocation resource component 350 or death benefit for the second predetermined time interval to be the greater of the life event allocation product 334 and the resource ceiling value 336/face value (e.g., 250,000 at cell F3).

At block 560, in some embodiments, the system may then construct a second total long term/LTC resource availability 360 (e.g., total LTC benefit of value) for the second predetermined time interval based on varying the first total LTC resource availability 360 in accordance with the identified cumulative growth rate 340. As illustrated by cell 13 of FIGS. 5A-5B, the system varies the first total LTC resource availability (cell 12 having a value of 350,000) in direct proportion with the cumulative growth rate 340 (5% at cell J3). Accordingly, the second total LTC resource availability 360 for the second predetermined time interval is determined to be 367,500 at cell 13 based on increasing the first total LTC resource availability (cell 12 having a value of 350,000) by 5% (associated cumulative growth rate 340).

Next, at block 570, the system may then determine a second LTC acceleration resource value (LTC acceleration of death benefit rider) for the second predetermined time interval, in some embodiments. The LTC acceleration resource value may be constant at the value of 175,000 at cell G3.

At block 580, based on at least (i) the determined second total LTC resource availability 360, also referred to as a second long term resource availability (e.g., total LTC benefit of value) (ii) the corresponding determined second LTC acceleration resource value 370 (LTC acceleration of death benefit rider), the system may determine an associated second extended resource value 380 (e.g., extension of benefits rider) for the second predetermined time interval, in some embodiments. As illustrated by cell H3 of FIGS. 5A-5B, the second extended resource value 380 may be determined to be 192,500 at cell H3 based on subtracting the second LTC acceleration resource value 370 (175,000 at cell G3) from the second total LTC resource availability 360 of 367,500 at cell 13.

At block 590, in some embodiments, the system may transform the second adapted resource component 330 by implementing a second dynamic index for the duration of the second time period. The steps 510-590 are performed for all subsequent time periods in a similar manner until all of the plurality of time periods have been implemented. However, it is noted that, in the instance of a negative cumulative growth rate 340 (loss or reduction), the system may further implement a floor value for the total LTC resource availability 360 (e.g., total LTC benefit of value). Here, in the event that the total LTC resource availability 360 falls below a predetermined threshold (floor value) when proportionally changed with respect to the negative cumulative growth rate, the system may assign the predetermined threshold (floor value) as the total LTC resource availability 360. As illustrated by cell J5 of FIGS. 5A-5B, the cumulative growth rate 340 at the beginning of the fourth time interval may comprise a reduction of −2.25% (based on reduction of the adapted resource component B5 to 8,204 from cumulative resource transfer value 80,000 at block L5). Because, the 2.25% reduction of the total LTC resource availability 360 of 350,000 (cell 12) falls below a predetermined threshold/floor value (e.g., 350,000 or another value), the system may assign the predetermined threshold/floor value of 350,000 to the total LTC resource availability 360 at cell IS.

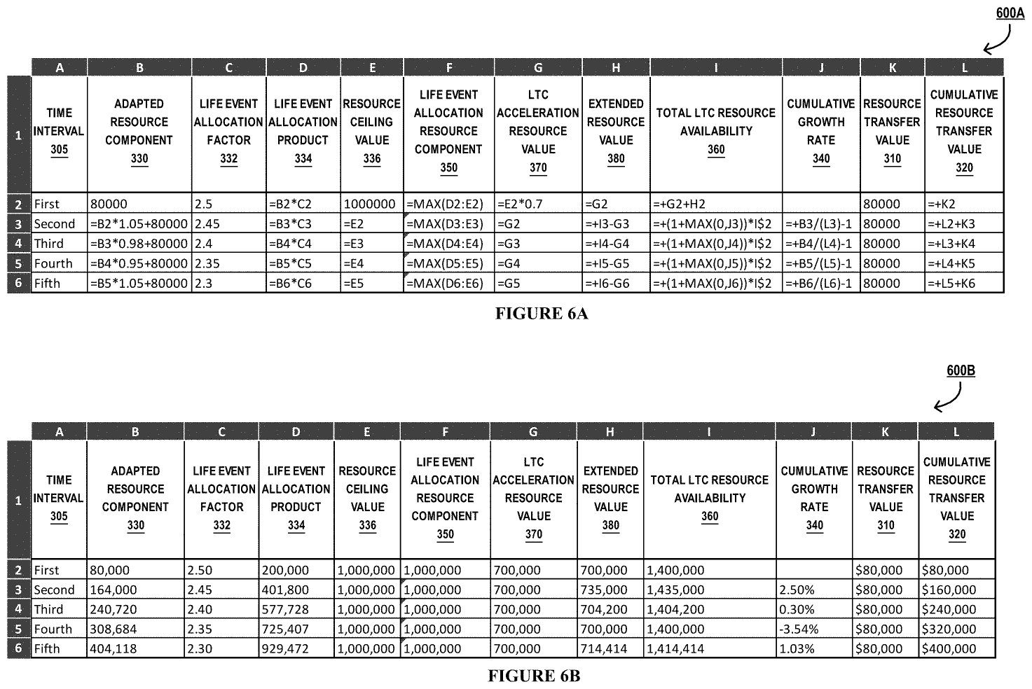

FIGS. 6A and 6B illustrate a multi-pay market growth type dynamic resource allocation implementation 600A-600B, in accordance with some embodiments of the invention. Specifically, FIG. 6A illustrates the variables and calculations, while FIG. 6B illustrates the corresponding illustrative numerical result. The multi-pay market growth type dynamic resource allocation implementation 600A-600B is substantially similar to that of the example 500A-500B except for additional periodic resource transfer values 310 (e.g., premium) at every timer interval, as indicated by column K and corresponding increase in the cumulative resource transfer value 320 at column L.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more special-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for implementing dynamic resource allocation, wherein the system is configured for transformation of resource allocations of predetermined intervals based on dynamic indices, the system comprising:
at least one memory device with computer-readable program code stored thereon;
at least one communication device;
at least one processing device operatively coupled to the at least one memory device and the at least one communication device, wherein executing the computer-readable program code is configured to cause the at least one processing device to:
receive, via an operative communication channel, a request from a user to implement a dynamic resource allocation associated with a predetermined user resource, from a user device;
configure the dynamic resource allocation based on at least analyzing the user request, wherein configuring the dynamic resource allocation comprises determining a plurality of time intervals associated with the dynamic resource allocation;
initiate, via the operative communication channel, a first resource transfer from a user resource for a first time interval of the plurality of time intervals, wherein the first resource transfer comprises a first resource transfer value;
implement the dynamic resource allocation for the plurality of time intervals, wherein implementing the dynamic resource allocation comprises, for a predetermined time interval of the plurality of time intervals:
determining an adapted resource component associated with the predetermined time interval;
determining a cumulative growth rate associated with the adapted resource component, wherein the cumulative growth rate comprises a rate of change of the adapted resource component from a preceding first dynamic index implementation of the adapted resource component at a prior time interval directly preceding the predetermined time interval;
constructing a total long term resource availability component for the predetermined time interval based on varying a prior total long term resource availability in direct proportion with the cumulative growth rate, wherein the prior total long term resource availability is associated with the prior time interval directly preceding the predetermined time interval; and
transforming the adapted resource component by implementing the adapted resource component in a second dynamic index for the predetermined time interval;
transmit a notification to the user device indicating completion of the dynamic resource allocation.

2. The system of claim 1, wherein executing the computer-readable program code is configured to further cause the at least one processing device to:
determine a long term acceleration resource value for the predetermined time interval; and
based on at least (i) the determined total long term resource availability and (ii) the determined long term acceleration resource value, determine an associated extended resource value for the predetermined time interval.

3. The system of claim 1, wherein the predetermined time interval of the plurality of time intervals comprises a second time interval of the plurality of time intervals succeeding the first time interval, wherein executing the computer-readable program code is configured to further cause the at least one processing device to:
initiate, via the operative communication channel, a second resource transfer from the user resource for the second time interval of the plurality of time intervals, wherein the second resource transfer comprises a second resource transfer value;
wherein the adapted resource component associated with the predetermined time interval is determined based on a combination of the first resource transfer value and the second resource transfer value.

4. The system of claim 1, wherein executing the computer-readable program code is configured to further cause the at least one processing device to:
determine that the cumulative growth rate associated with the adapted resource component comprises a negative value; and
in response to determining that the constructed total long term resource availability component for the predetermined time interval is below a predetermined threshold floor value, automatically and in real-time, construct the total long term resource availability component such that the total long term resource availability component comprises the predetermined threshold floor value.

5. The system of claim 1, wherein executing the computer-readable program code is configured to further cause the at least one processing device to determine a life event allocation resource component for the predetermined time interval.

6. The system of claim 1, wherein configuring the dynamic resource allocation further comprises receiving a user input comprising the first resource transfer value, the dynamic index, and/or at least one life event allocation resource component associated with the dynamic resource allocation.

7. The system of claim 1, wherein the dynamic resource allocation is associated with a long term care (LTC) type.

8. The system of claim 1, wherein executing the computer-readable program code is configured to further cause the at least one processing device to:
identify a life event modification trigger associated with the predetermined time interval; and
in response to identifying the life event modification trigger, automatically and in real-time, modify the dynamic resource allocation for a second time interval of the plurality of time intervals succeeding the predetermined time interval.

9. The system of claim 1, wherein the predetermined time interval is the first time interval of the plurality of time intervals.

10. A computer program product for implementing dynamic resource allocation, wherein the computer program product is configured for transformation of resource allocations of predetermined intervals based on dynamic indices, the computer program product comprising a non-transitory computer-readable storage medium having computer-executable instructions to:
receive, via an operative communication channel, a request from a user to implement a dynamic resource allocation associated with a predetermined user resource, from a user device;
configure the dynamic resource allocation based on at least analyzing the user request, wherein configuring the dynamic resource allocation comprises determining a plurality of time intervals associated with the dynamic resource allocation;
initiate, via the operative communication channel, a first resource transfer from a user resource for a first time interval of the plurality of time intervals, wherein the first resource transfer comprises a first resource transfer value;
implement the dynamic resource allocation for the plurality of time intervals, wherein implementing the dynamic resource allocation comprises, for a predetermined time interval of the plurality of time intervals:
determining an adapted resource component associated with the predetermined time interval;
determining a cumulative growth rate associated with the adapted resource component, wherein the cumulative growth rate comprises a rate of change of the adapted resource component from a preceding first dynamic index implementation of the adapted resource component at a prior time interval directly preceding the predetermined time interval;
constructing a total long term resource availability component for the predetermined time interval based on varying a prior total long term resource availability in direct proportion with the cumulative growth rate, wherein the prior total long term resource availability is associated with the prior time interval directly preceding the predetermined time interval; and
transforming the adapted resource component by implementing the adapted resource component in a second dynamic index for the predetermined time interval;
transmit a notification to the user device indicating completion of the dynamic resource allocation.

11. The computer program product of claim 10, wherein the non-transitory computer-readable storage medium further comprises computer-executable instructions to:
determine a long term acceleration resource value for the predetermined time interval; and
based on at least (i) the determined total long term resource availability and (ii) the determined long term acceleration resource value, determine an associated extended resource value for the predetermined time interval.

12. The computer program product of claim 10, wherein the predetermined time interval of the plurality of time intervals comprises a second time interval of the plurality of time intervals succeeding the first time interval, wherein the non-transitory computer-readable storage medium further comprises computer-executable instructions to:
initiate, via the operative communication channel, a second resource transfer from the user resource for the second time interval of the plurality of time intervals, wherein the second resource transfer comprises a second resource transfer value;
wherein the adapted resource component associated with the predetermined time interval is determined based on a combination of the first resource transfer value and the second resource transfer value.

13. The computer program product of claim 10, wherein the non-transitory computer-readable storage medium further comprises computer-executable instructions to:
determine that the cumulative growth rate associated with the adapted resource component comprises a negative value; and
in response to determining that the constructed total long term resource availability component for the predetermined time interval is below a predetermined threshold floor value, automatically and in real-time, construct the total long term resource availability component such that the total long term resource availability component comprises the predetermined threshold floor value.

14. The computer program product of claim 10, wherein the non-transitory computer-readable storage medium further comprises computer-executable instructions to determine a life event allocation resource component for the predetermined time interval.

15. The computer program product of claim 10, wherein the dynamic resource allocation is associated with a long term care (LTC) type.

16. A method for implementing dynamic resource allocation, wherein the method is configured for transformation of resource allocations of predetermined intervals based on dynamic indices, the method comprising:
receiving, via an operative communication channel, a request from a user to implement a dynamic resource allocation associated with a predetermined user resource, from a user device;
configuring the dynamic resource allocation based on at least analyzing the user request, wherein configuring the dynamic resource allocation comprises determining a plurality of time intervals associated with the dynamic resource allocation;
initiating, via the operative communication channel, a first resource transfer from a user resource for a first time interval of the plurality of time intervals, wherein the first resource transfer comprises a first resource transfer value;
implementing the dynamic resource allocation for the plurality of time intervals, wherein implementing the dynamic resource allocation comprises, for a predetermined time interval of the plurality of time intervals:
determining an adapted resource component associated with the predetermined time interval;
determining a cumulative growth rate associated with the adapted resource component, wherein the cumulative growth rate comprises a rate of change of the adapted resource component from a preceding first dynamic index implementation of the adapted resource component at a prior time interval directly preceding the predetermined time interval;
constructing a total long term resource availability component for the predetermined time interval based on varying a prior total long term resource availability in direct proportion with the cumulative growth rate, wherein the prior total long term resource availability is associated with the prior time interval directly preceding the predetermined time interval; and
transforming the adapted resource component by implementing the adapted resource component in a second dynamic index for the predetermined time interval;
transmitting a notification to the user device indicating completion of the dynamic resource allocation.

17. The method of claim 16, wherein the method further comprises:
determining a long term acceleration resource value for the predetermined time interval; and
based on at least (i) the determined total long term resource availability and (ii) the determined long term acceleration resource value, determining an associated extended resource value for the predetermined time interval.

18. The method of claim 16, wherein the predetermined time interval of the plurality of time intervals comprises a second time interval of the plurality of time intervals succeeding the first time interval, wherein the method further comprises:
initiating, via the operative communication channel, a second resource transfer from the user resource for the second time interval of the plurality of time intervals, wherein the second resource transfer comprises a second resource transfer value;
wherein the adapted resource component associated with the predetermined time interval is determined based on a combination of the first resource transfer value and the second resource transfer value.

19. The method of claim 16, wherein the method further comprises:
determining that the cumulative growth rate associated with the adapted resource component comprises a negative value; and
in response to determining that the constructed total long term resource availability component for the predetermined time interval is below a predetermined threshold floor value, automatically and in real-time, constructing the total long term resource availability component such that the total long term resource availability component comprises the predetermined threshold floor value.

20. The method of claim 16, wherein the method further comprises determining a life event allocation resource component for the predetermined time interval.
